(19) United States
(12) Patent Application Publication
(10) Pub. No.: US 2015/0099838 A1
(43) Pub. Date: Apr. 9, 2015

(54) High heat resistant polyamide for down hole oil components

(71) Applicant: SOLVAY SPECIALTY POLYMERS USA, LLC., Alpharetta, GA (US)

(72) Inventors: Brian Baleno, Alpharetta, GA (US); Linda M. Norfolk, Cumming, GA (US)

(73) Assignee: SOLVAY SPECIALTY POLYMERS USA, LLC., Alpharetta, GA (US)

(21) Appl. No.: 14/356,454

(22) PCT Filed: Nov. 6, 2012
(86) PCT No.: PCT/EP2012/071891

§ 371 Date: May 6, 2014

Related U.S. Application Data
(60) Provisional application No. 61/557,137, filed on Nov. 8, 2011.

(51) Int. Cl. E21B 17/10; C08L 77/00

(52) U.S. Cl. CPC E21B 17/1071; C08L 77/00
USPC 524/377; 524/398

(57) ABSTRACT

High heat resistant polyamide for down hole oil components Rod guides comprising a high heat resistant polyamide composition comprising at least one polyamide and at least one heat stabilizing additive selected from elemental iron and polyhydric alcohol.

This application claims priority to U.S. provisional application No. 61/557,137 filed on Nov. 8, 2011, the whole content of this application being incorporated herein by reference for all purposes.

### TECHNICAL FIELD

The invention pertains to production equipment for oil or gas wells such as rod guides and in particular sucker rod guides that are formed or installed on sucker rods of deep wells.

### BACKGROUND ART

Oil and gas are usually extracted from underground reservoirs using oil/gas wells. Extracting crude oil/gas starts with drilling wells into underground reservoirs. A steel tubing is then placed in the hole to provide structural integrity to the newly drilled wellbore. Holes are then made in the base of the well to enable oil/gas to pass into the bore.

As is well known in the art of boring of deep wells, it is extremely difficult and, in fact, practically impossible to obtain a straight bore. When the steel tubing is inserted in the well and the pump rods (also called sucker rods, i.e. steel rods, typically between 7 to 9 meters in length, used to join together the surface and downhole components of a reciprocating piston pump which may be several thousand feet below the surface) are directed there through, these rods will engage against the sides of the steel tubing at a number of points.

Since the sucker rod is under considerable strain and stresses including compression, vibration, tension, torsion and bending, and because of its relatively small size, the additional friction between the walls of the tubing is to be avoided. The friction between the tubing and the sucker rod is in fact detrimental on both sides since it has a tendency to destroy both the sucker rod and the tubing.

Devices such as rod guides formed or installed on sucker rods have been constructed for the purpose of maintaining the sucker rods in spaced relation to the walls of the tubing thereby controlling rod and tubing wear.

Rod guides include a generally cylindrically-shaped body that is molded or placed in intimate contact with the sucker rod. The body is simultaneously molded with a plurality of blades that extend radially from the body. As used herein, the term “blade” refers to the molded portion of the rod guide that extends from the body.

Rod guides are thus designed to fit on sucker rods used, for example, to pump oil wells in order to eliminate, or at least greatly reduce, many of the down-hole problems which are characteristic of production equipment in oil wells. These guides are generally characterized by a coefficient of friction which, when wet, is lower than that of metal. Rod guides operate to increase the overall pumping efficiency of the wells, while at the same time prevent undesirable metal-to-metal contact between the sucker rods and the stationary tubing. Tubing wear, often unseen until failure occurs, is also reduced because the rod guides receive the wear rather than the expensive tubing. Therefore, a properly designed rod guide installation can result in significant savings in both equipment replacement and service costs in a pumping oil well.

As the rod guide is used within the production tubing, the outer extremities of the guide blades wear away. Once the blades wear down to a point where a coupling between rod guide segments contacts the production tubing, the rod guide must be replaced.

Prior art sucker rod guides were made of various materials, including some high performance polymers such as aliphatic polyamide (Nylon), polyether ether ketone (PEEK), polyphthalamide (PPA), polyphenylene sulfide (PPS), and neoprene rubber. Each one of those materials presents some specific drawbacks. For example, as the rod guide reciprocates with the sucker rod inside the tubing, it has been found that friction between neoprene rubber rod guides and the tubing sometimes generates heat which may result in a fairly rapid deterioration of the neoprene material, thereby necessitating the frequent replacement of the neoprene rubber rod guides. Furthermore, it has been found that nylon rod guides are brittle and are sometimes difficult to mount on a sucker rod without breaking, especially in cold weather. Also, even if Nylon, PPA and PPS have demonstrated good performance in a number of harsh environments, none of them can withstand high temperatures such as working temperatures of more than 200° C. PEEK exhibits overall good performances but remains too expensive.

In view of all the above, there is still a current shortfall in the art for rod guides featuring excellent wear characteristics, excellent resistance to a wide range of temperatures, in particular very high temperatures, and good chemical resistance to well fluids.

The Applicant has now found that it is possible to advantageously manufacture rod guides from a high heat resistant polyamide composition. The rod guides of the present invention provide, among others, all the above-mentioned desirable features and achieve greater service life, thereby reducing downtime and operating costs.

In addition to the above-mentioned benefits, it has also been found that the rod guides of this invention are not adversely affected by corrosive hydrogen sulfide, salt water, and other fluids and compounds normally found in an oil well.

### SUMMARY OF THE INVENTION

It is thus an object of the present invention, a rod guide for mounting on the sucker rod of an oil well and preventing, or at least minimizing, metal-to-metal contact between the sucker rod and the tubing. The invented rod guide comprises at least one part comprising a high heat resistant polyamide composition (C) comprising:
at least one polyamide;
at least one heat stabilizing additive selected from elemental iron and polyhydric alcohol.

These and other features and objects of the present invention will be apparent to those who are skilled in the art from a review of the following detailed description and drawing figures.

### BRIEF DESCRIPTION OF THE DRAWINGS

The invention will be better understood by reference to the accompanying drawings depicting prior art shapes for rod guides. The following drawings are illustrative only and not limiting in any way the scope of the present invention:

FIG. 1 is a perspective view of a rod guide constructed in accordance with the present invention showing a portion of a sucker rod with the balance cut away;

FIG. 2 is a perspective view of the rod guide shown in FIG. 1 in a different orientation;

FIG. 3 is a three-dimensional view of a snap-on rod guide according to a specific embodiment of the present invention.

### DESCRIPTION OF PREFERRED EMBODIMENTS

### The Rod Guide

The object of the invention is a rod guide made of a high heat resistant polyamide composition (C) comprising:
at least one polyamide;
at least one heat stabilizing additive selected from elemental iron and polyhydric alcohol.

A rod guide is a generally cylindrically-shaped body that is intended to be positioned in intimate contact with the sucker rod with the purpose of maintaining the sucker rods in spaced relation to the walls of a steel tubing. Rod guides comprise a central body provided with at least two blades.

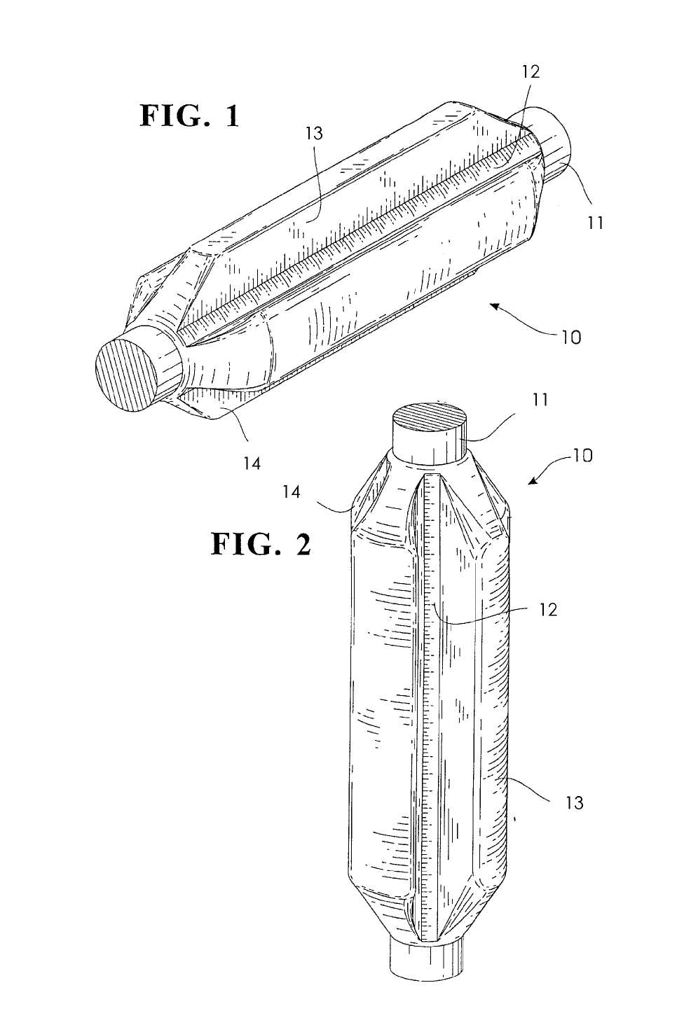

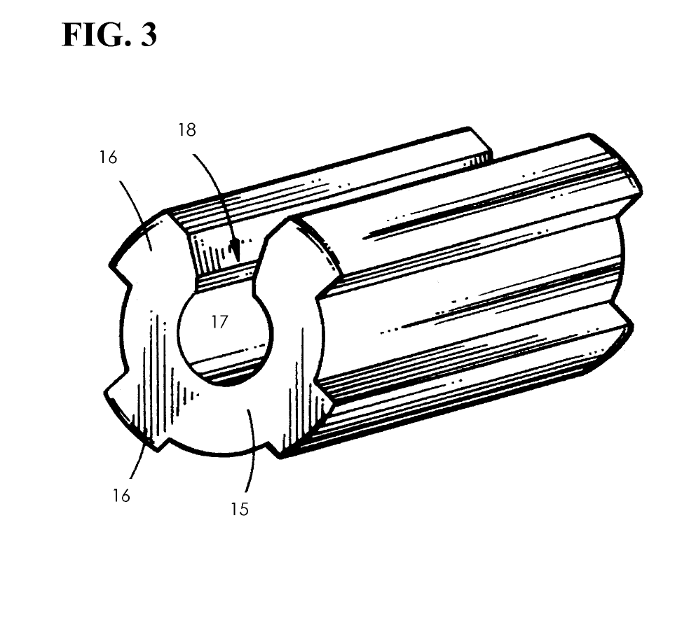

FIGS. 1 and 2 show a possible shape of the rod guide while FIG. 3 shows a snap-on rod guide according to the present invention.

In a first embodiment, the rod guide according to the invention is as depicted in FIGS. 1 and 2 which illustrate perspective views of a rod guide (10) according to the present invention. The rod guide (10) operates with and is adhesively bonded to a cylindrical sucker rod (11), a portion of which is visible in FIGS. 1 and 2. The sucker rod (11) extends through the entire length of the rod guide.

In one known application, the sucker rod (11) will extend from the surface downhole to a production area. The sucker rod (11) will reciprocate in the well bore or steel tubing. The rod will be powered or driven from the surface and will drive a downhole pump or other tool. Fluid in the production area will be brought to the surface in the space between the rod (11) and a well bore or tubing string (not shown).

A cylindrical body (12) of the rod guide surrounds the circumference of the rod. The cylindrical body (12) is also coaxial with the sucker rod (11) which passes through the cylindrical opening in the body (12).

The rod guide (10) also includes a first pair of opposed blades (13 and 14) which extend radially from the cylindrical body (12).

In another particular embodiment, the rod guide according to the invention is a field installable or snap-on rod guide comprising a high heat resistant polyamide composition (C) comprising:
at least one polyamide;
at least one heat stabilizing additive selected from elemental iron and polyhydric alcohol; and
an impact modifier.

FIG. 3 depicts a section view of a field installable or snap-on rod guide according to the present invention comprising a body (15), a plurality of blades (16), a center-hole (17), and an axial access channel (18).

In a particular embodiment, the rod guide body and the rod guide blades are made of the same composition (C).

In a second particular embodiment, the rod guide body and the rod guide blades are not made of the same composition. In this second embodiment, the rod guide body is made of a commodity material while the rod guide blades are made of the above-mentioned polymer composition (C).

In another particular embodiment, the blades are made of different colors or provide a wear gauge feature to visually indicate when the blades of the rod guide should be replaced. A single rod guide body is adapted to receive a variety of blade sizes so that a single tooling for the rod guide body accommodates any of the standard production tubing inside diameters. All of these factors reduce tooling and production costs and enhance the adaptability of the rod guide to a variety of down-hole conditions.

It will be further appreciated by those skilled in the art that the rod guide of the present invention is characterized by a high degree of utility, reliability and longevity, in that it is made of a high heat resistant polyamide composition (C) which has good self-lubricating and/or wet-lubricating characteristics, high abrasion resistance and toughness, excellent thermal resistance, and the necessary resiliency to facilitate mounting on a sucker rod without shattering, deforming or moving excessively on the sucker rod. Furthermore, the sucker rod guide can be constructed to any specifications for fitting on a sucker rod of any outside diameter and is quickly and easily installed on the sucker rod using conventional tools and equipment.

The rod guide according to the present invention may be manufactured by well known method in the art, including but not limited to injection and molding of the polyamide composition (C).

### The Polyamide

The term “polyamide” is generally understood to indicate a polymer comprising units deriving from at least one diamine and at least one dicarboxylic acid and/or from at least one amino carboxylic acid or lactam.

The polyamide present in the polyamide composition (C) may be an aliphatic or a semi-aromatic polyamide.

An aliphatic polyamide is intended to denote any polyamide of which more than 50 mole % of the recurring units are obtained by the polycondensation reaction between an aliphatic diacid (and/or a derivative thereof) and an aliphatic diamine, and/or by the auto-polycondensation reaction of an amino carboxylic acid, and/or by the auto-polycondensation reaction of a lactam.

The aliphatic polyamide is preferably chosen from PA 6, PA 6,6 and PA 12. More preferably, the aliphatic polyamide is PA 6,6, i.e. the polyamide obtained by the polycondensation reaction between 1,6-hexamethylenediamine and adipic acid.

The polyamide present in the polyamide composition (C) is preferably a semi-aromatic polyamide.

A semi-aromatic polyamide is intended to denote any polyamide comprising more than 35 mol % of aromatic recurring units. It comprises advantageously more than 55 mol %, preferably more than 65 mol % of aromatic recurring units, more preferably more than 70 mol %, still more preferably more than 80 mol %, even more preferably more than 85 mol %, and most preferably more than 90 mol %.

In a specific embodiment, the polyamide of the composition (C) comprises 100 mol % of aromatic recurring units. For the purpose of the present invention, the term “aromatic recurring unit” is intended to denote any recurring unit that comprises at least one aromatic group. The aromatic recurring units may be formed by the polycondensation of at least one aromatic dicarboxylic acid and at least one diamine or by the polycondensation of at least one dicarboxylic acid and at least one aromatic diamine.

Non-limitative examples of aromatic dicarboxylic acids are notably phthalic acids, including isophthalic acid; terephthalic acid and orthophthalic acid; naphtalenedicarboxylic acids (including 2,6-naphthalene dicarboxylic acid; 2,7-naphthalene dicarboxylic acid; 1,4-naphthalene dicarboxylic acid; 2,3-naphthalene dicarboxylic acid; 1,8-naphthalene dicarboxylic acid; and 1,2-naphthalene dicarboxylic acid); 2,5-pyridinedicarboxylic acid; 2,4-pyridinedicarboxylic acid; 3,5-pyridinedicarboxylic acid; 2,2-bis(4-carboxyphenyl)propane; bis(4-carboxyphenyl)methane; 2,2-bis(4-carboxyphenyl)hexafluoropropane; 2,2-bis(4-carboxyphenyl)ketone; 4,4′-bis(4-carboxyphenyl)sulfone; 2,2-bis(3-carboxyphenyl)propane; bis(3-carboxyphenyl)methane; 2,2-bis(3-carboxyphenyl)hexafluoropropane; 2,2-bis(3-carboxyphenyl)ketone; and bis(3-carboxyphenoxy)benzene. Phthalic acids, including isophthalic acid, terephthalic acid and orthophthalic acid, are the preferred aromatic dicarboxylic acids. Terephthalic acid and isophthalic acid are even more preferred.

Non-limitative examples of aromatic diamines are notably meta-phenylene diamine, meta-xylylene diamine, and para-xylylene diamine.

The polyamide of the composition (C) may comprise of, in addition to the at least one aromatic dicarboxylic acid and/or at least one aromatic diamine described above, recurring units deriving from at least one aliphatic dicarboxylic acid and/or at least one aliphatic diamine and/or at least one lactam.

Non-limitative examples of aliphatic dicarboxylic acids are notably oxalic acid (HOOC—COOH); malonic acid (HOOC—CH₂—COOH); succinic acid [HOOC—(CH₂)₂—COOH]; glutaric acid [HOOC—(CH₂)₃—COOH]; 2,2-dimethyl-glutaric acid [HOOC—C(CH₃)₂—(CH₂)₂—COOH]; adipic acid [HOOC—(CH₂)₄—COOH]; 2,4,4-trimethyl-adipic acid [HOOC—CH(CH₃)—CH₂—C(CH₃)₂—CH₂—COOH]; pimelic acid [HOOC—(CH₂)₅—COOH]; suberic acid [HOOC—(CH₂)₆—COOH]; azelaic acid [HOOC—(CH₂)₇—COOH]; sebacic acid [HOOC—(CH₂)₈—COOH]; undecanedioic acid [HOOC—(CH₂)₉—COOH]; dodecanedioic acid [HOOC—(CH₂)₁₀—COOH]; tetradecanedioic acid [HOOC—(CH₂)₁₁—COOH]; and 1,4-cyclohexane dicarboxylic acid. Sebacic acid, adipic acid, and 1,4-cyclohexane dicarboxylic acid are preferred.

Non-limiting example of aliphatic diamines are notably 1,2-diaminoethane; 1,2-diaminopropane; propylene-1,3-diamine; 1,3-diaminobutane; 1,4-diaminobutane; 1,5-diaminopentane; 2-methyl-1,5-diaminopentane; 1,6-hexamethylenediamine; 2,4,4-trimethyl-1,6-hexamethylenediamine; 1,8-diaminooctane; 2-methyl-1,8-diaminooctane; 1,9 nonanediamine; 5-methyl-1,9-nonanediamine; 1,10-diaminodecane; 1,11-diaminoundecane; 1,12-diaminododecane; 1,13-diaminotridecane; 1,14-diaminotetradecane; 1,16-diaminohexadecane; 1,18-diaminooctadecane; and 1-amino-3-N-methyl-N-(3-aminopropyl)-aminopropane. Among those, 1,6-hexamethylenediamine; 2-methyl-1,8-diaminooctane; 1,9 nonanediamine; 5-methyl-1,9-nonanediamine; 1,10-diaminodecane; 1,11-diaminoundecane; and 1,12-diaminododecane are preferred and 1,6-hexamethylenediamine; 1,9 nonanediamine; and 1,10-diaminodecane are even more preferred.

In a first embodiment, the polyamide of the composition (C) is preferably a polyphthalamide (PPA). For the purpose of the present description, the term “polyphthalamides” should be understood as defining any polymer of which more than 70 mol %, preferably more than 80 mol %, more preferably more than 90 mol % of the recurring units are formed by the polycondensation reaction between at least one phthalic acid and at least one diamine. The phthalic acid can be notably o-phthalic acid, isophthalic acid, or terephthalic acid. The diamine can be notably 1,6-hexamethylenediamine; 1,9-nonanediamine; 1,10-diaminodecane 2-methyl-octanediamine; 2-methyl-1,5-pentanediamine; or 1,4-diaminobutane; a C₆ and/or a C₁₀ diamine, especially 1,6-hexamethylenediamine and 1,10-diaminodecane, are preferred. Suitable polyphthalamides are notably available as AMODEL® polyphthalamides from Solvay Specialty Polymers USA, LLC.

The polyphthalamide (PPA) of the composition (C) is more preferably a polyterephthalamide. For the purpose of the present description, the term “polyterephthalamide” should be understood as defining any polymer of which more than 70 mol %, preferably more than 80 mol %, more preferably more than 90 mol % of the recurring units are formed by the polycondensation reaction between at least terephthalic acid with at least one diamine. The diamine may be aliphatic or aromatic. It is preferably an aliphatic diamine selected from the group consisting of 1,6-hexamethylenediamine; 1,9-nonanediamine; 1,10-diaminodecane; 2-methyl-octanediamine; 2-methyl-1,5-pentanediamine; or 1,4-diaminobutane.

Excellent results were obtained when the polyphthalamide is selected from the group consisting of PA 6T, PA9T, PA10T, PA11T, PA12T, PA6T/6I, PA6T/6I/10T/10I, PA6T/10T/6,10/10,10, PA6T/11 and PA10T/11.

Of course, more than one polyamide may be used in the composition (C). The Applicant has surprisingly found out that the addition of PA 6 and/or PA 6,6 to compositions comprising semi-aromatic polyamides and elemental iron lead to unexpected outstanding results regarding the heat aging performance while maintaining all the other properties of semi-aromatic polyamides at a very good level. Compositions comprising semi-aromatic polyamides, PA 6 and/or PA 6,6 and elemental iron are described in U.S. provisional application 61/495,024, the whole content of which is being incorporated herein by reference for all purposes.

Therefore, in a specific embodiment of the present invention, the rod guide comprises a high heat resistant polyamide composition (C) comprising:

at least one semi-aromatic polyamide and preferably a polyphthalamide;

at least one aliphatic polyamide selected from PA 6 and PA 6,6; and

elemental iron.

When present, the at least one aliphatic polyamide selected from PA 6 and PA 6,6 is preferably present in the polyamide composition (C) in an amount of at least 1 wt. %, preferably of at least 2 wt. %, more preferably of at least 2.5 wt. %, still more preferably of at least 3 wt. % and most preferably of at least 4 wt. %, based on the total weight of the polyamide composition (C). Besides, the at least one aliphatic polyamide is generally present in the polyamide composition (C) in an amount of at most 20 wt. %, preferably of at most 18 wt. %, more preferably of at most 16 wt. %, still more preferably of at most 14 wt. % and most preferably of at most 12 wt. %, based on the total weight of the polyamide composition (C).

The polyamide of the composition (C) may be semi-crystalline or amorphous.

When the polyamide of the composition (C) is semi-crystalline, it has a melting point advantageously greater than 220° C., preferably greater than 270° C., more preferably greater than 280° C., and still more preferably greater than 320° C. In addition, the polyamide of the composition (C) has a melting point advantageously of below 350° C., preferably below 340° C. and more preferably below 330° C.

The melting point of the polyamide of the composition (C) was measured by Differential Scanning calorimetry using ASTM D3418 with the following heating/cooling cycle: first heating from room temperature up to 350° C. at a rate of 10° C./min, followed by cooling from 350° C. down to room temperature at a rate of 20° C./min, followed by second heating from room temperature up to 350° C. at a rate of 10° C./min. The melting point was measured during second heating.

When the polyamide of the composition (C) is amorphous, it has a glass transition temperature (Tg) advantageously greater than 160° C., preferably greater than 180° C., more preferably greater than 200° C., and still more preferably greater than 220° C. In addition, the polyamide of the composition (C) has a glass transition temperature advantageously of below 350° C., preferably below 340° C. and more preferably below 330° C.

The glass transition temperature of the polyamide of the composition (C) was also measured by Differential Scanning calorimetry using ASTM D3418 as described above.

The polyamide is generally present in the polymer composition (C) in an amount of at least 30 wt %, preferably of at least 35 wt %, more preferably of at least 40 wt %, still more preferably of at least 45 wt % and most preferably of at least 50 wt %, based on the total weight of the composition (C). Besides, the semi-aromatic polyamide is generally present in the polymer composition (C) in an amount of at most 85 wt %, preferably of at most 80 wt %, more preferably of at most 75 wt %, still more preferably of at most 70 wt % and most preferably of at most 65 wt %, based on the total weight of the composition (C).

### The Heat Stabilizing Additive

The composition (C) further comprises at least one heat stabilizing additive selected from elemental iron and polyhydric alcohol.

The Elemental Iron

Elemental iron is preferably in the form of particles, the majority of which have a small particle size, such as a powder. In general, the elemental iron has a weight average particle size of at most 450 μm, preferably at most 200 μm, more preferably at most 100 μm, and still more preferably at most 50 μm. On the other side, the elemental iron has a weight average particle size of at least 10 μm, preferably at least 13 μm, more preferably at least 15 μm, still more preferably at least 18 μm, and most preferably at least 20 μm.

The elemental iron of the composition (C) has preferably a weight average particle size of 10 to 50 μm, more preferably 15 to 45 μm, still more preferably 20 to 40 μm and most preferably 25 to 35 μm.

The weight average particle size is determined as Dₘ according to ASTM D1921-89, method A. Preferably the size, to be understood as the largest dimension, of at least 99 wt % of the elemental iron particles is at most 450 μm and preferably at most 200 μm, more preferably at most 100 μm, even more preferably at most 90 μm, still more preferably at most 80 μm, and most preferably at most 70 μm.

Preferably the size, to be understood as the smallest dimension, of at least 99 wt % of the elemental iron particles is at least 10 μm and preferably at least 15 μm, more preferably at least 20 μm, and most preferably at least 25 μm.

The elemental iron in the composition (C) may be used in any amount, which can be varied over a wide range. The elemental iron has shown to be a very effective stabilizer, showing an effect already at very low amounts.

The elemental iron is generally present in the composition (C) in an amount of at least 0.1 wt %, preferably of at least 0.2 wt %, more preferably of at least 0.5 wt %, still more preferably of at least 0.9 wt % and most preferably of at least 1.0 wt %, based on the total weight of the composition (C). Besides, the elemental iron is generally present in the composition (C) in an amount of at most 10 wt %, based on the total weight of the composition (C). Higher amounts of elemental iron may be used, however, without any additional effect on the heat aging properties of the composition (C). More preferably, the elemental iron is generally present in the composition (C) in an amount of at most 5 wt %, more preferably of at most 4 wt %, still more preferably of at most 3 wt % and most preferably of at most 2.5 wt %, based on the total weight of the composition (C).

Excellent results were obtained when the elemental iron was used in an amount ranging from 0.1 to 5 wt %, preferably from 0.5 to 3 wt % and most preferably from 0.9 to 2.5 wt %, based on the total weight of the composition (C).

The use of elemental iron for conferring heat resistance properties to thermoplastic polymers such as polyamides and the preparation of such compositions is described in U.S. Pat. No. 7,763,674 B, the whole content of which is being incorporated herein by reference for all purposes.

The Polyhydric Alcohol

The polyhydric alcohol used in the composition (C) has more than two hydroxyl groups and features a number average molecular weight (Mₙ) of less than 2000.

Polyhydric alcohols may be selected from aliphatic hydroxylic compounds containing more than two hydroxyl groups, aliphatic-cycloaliphatic compounds containing more than two hydroxyl groups, cycloaliphatic compounds containing more than two hydroxyl groups, aromatic hydroxylic compounds containing more than two hydroxyl groups, and saccharides.

An aliphatic chain in the polyhydric alcohol can include not only carbon atoms but also one or more hetero atoms which may be selected, for example, from nitrogen, oxygen and sulphur atoms. A cycloaliphatic ring present in the polyhydric alcohol can be monocyclic or part of a bicyclic or polycyclic ring system and may be carbocyclic or heterocyclic. A heterocyclic ring present in the polyhydric alcohol can be monocyclic or part of a bicyclic or polycyclic ring system and may include one or more hetero atoms which may be selected, for example, from nitrogen, oxygen and sulphur atoms. The one or more polyhydric alcohols may contain one or more substituents, such as ether, carboxylic acid, carboxylic acid amide, or carboxylic acid ester groups. Examples of polyhydric alcohol containing more than two hydroxyl groups include, without limitation: triols, such as glycerol; trimethylolpropane; 2,3-di-(2′-hydroxyethyl)-cyclohexan-1-ol; hexane-1,2,6-triol; 1,1,1-tris-(hydroxymethyl)ethane; 3-(2′-hydroxyethoxy)-propane-1,2-diol; 3-(2′-hydroxypropoxy)-propane-1,2-diol; 2-(2′-hydroxyethoxy)-hexane-1,2-diol; 6-(2′-hydroxypropoxy)-hexane-1,2-diol; 1,1,1-tris-[(2′-hydroxyethoxy)-methyl]-ethane; 1,1,1-tris-[(2′-hydroxypropoxy)-methyl]-propane; 1,1,1-tris-(4′-hydroxyphenyl)-ethane; 1,1,1-tris-(hydroxyphenyl)-propane; 1,1,3-tris-(dihydroxy-3-methylphenyl)-propane; 1,1,4-tris-(dihydroxyphenyl)-butane; 1,1,5-tris-(hydroxyphenyl)-3-methylpentane; di-trimethylopropane; trimethylolpropane ethoxylates; or trimethylolpropane propoxylates;

polyols such as pentaerythritol, dipentaerythritol, and tripentaerythritol; and saccharides, such as cyclodextrin, D-mannose, glucose, galactose, sucrose, fructose, xylose, arabinose, D-mannitol, D-sorbitol, D- or L-arabitol, xylitol, iditol, talitol, allitol, altritol, guilitol, erythritol, threitol, and D-gulonic-y-lactone; and the like.

Preferred polyhydric alcohols include those having a pair of hydroxyl groups which are attached to respective carbon atoms which are separated one from another by at least one atom. Especially preferred polyhydric alcohols are those in which a pair of hydroxyl groups is attached to respective carbon atoms which are separated one from another by a single carbon atom.

Preferably, the polyhydric alcohol used in the polyamide composition (C) is pentaerythritol, dipentaerythritol, tripentaerythritol, di-trimethylolpropane, D-mannitol, D-sorbitol and xylitol. More preferably, the polyhydric alcohol used is dipentaerythritol and/or tripentaerythritol. A most preferred polyhydric alcohol is dipentaerythritol.

The polyhydric alcohol in the composition (C) may be used in any amount which can be varied over a wide range. The polyhydric alcohol has shown to be a very effective stabilizer, showing an effect already at very low amounts.

The polyhydric alcohol is generally present in the composition (C) in an amount of at least 0.1 wt %, preferably of at least 0.2 wt %, more preferably of at least 0.5 wt %, still more preferably of at least 0.9 wt % and most preferably of at least 1.0 wt %, based on the total weight of the composition (C). Besides, the polyhydric alcohol is generally present in the composition (C) in an amount of at most 10 wt %, based on the total weight of the composition (C). Higher amounts of polyhydric alcohol may be used, however without any additional effect on the heat aging properties of the composition (C). Preferably, the polyhydric alcohol is generally present in the composition (C) in an amount of at most 9 wt %, more preferably of at most 8 wt %, still more preferably of at most 7 wt %, even more preferably of at most 7 wt %, yet more preferably of at most 7 wt % and most preferably of at most 4 wt %, based on the total weight of the composition (C).

Preferably, the polyhydric alcohol is used in an amount ranging from 0.1 to 10 wt %, more preferably from 0.25 to 8 wt % even more preferably from 0.25 to 5 wt %, and most preferably from 1-4 wt %, based on the total weight of the composition (C).

The use of polyhydric alcohol for conferring heat resistance properties to thermoplastic polymers such as polyamides and the preparation of such compositions is described in WO 10/014,790, the whole content of which is being incorporated herein by reference for all purposes.

### The Impact Modifier

The impact modifiers useful herein are not particularly limited, so long as they impart useful properties to the composition (C), such as sufficient tensile elongation at yield and break. For example, any rubbery low-modulus functionalized polyolefin impact modifier with a glass transition temperature lower than 0° C. is suitable for this invention, including functionalized impact modifiers disclosed in U.S. Pat. No. 5,436,294 and U.S. Pat. No. 5,447,980. Useful impact modifiers include polyolefins, preferably functionalized polyolefins, and especially elastomers such as SEBS and EPDM.

Functionalized polyolefin impact modifiers are mostly preferred because of their good compatibility with polyamides. Non-limiting examples of such functionalized polyolefin impact modifiers are maleated polypropylenes and ethylene-propylene copolymers (available as EXXELOR™ PO), acrylate-modified polyethylenes (available as SURLYN®), methacrylic acid-modified polyethylene, acrylic acid-modified polyethylene (available as PRIMACOR®), maleic anhydride-modified styrene-ethylene-butylene-styrene (SEBS) block copolymer (available as KRATON®), and maleic anhydride-functionalized ethylene-propylene-diene monomer (EPDM) terpolymer rubber (available as ROYALTUF®).

Suitable functional groups on the impact modifier include any chemical moieties that can react with end groups of the polyamide to provide enhanced adhesion to the high temperature matrix.

Other functionalized polyolefin impact modifiers that may also be used in the practice of the invention include ethylene-higher alpha-olefin polymers and ethylene-higher alpha-olefin-diene polymers that have been provided with reactive functionality by being grafted or copolymerized with suitable reactive carboxylic acids or their derivatives such as, for example, acrylic acid, methacrylic acid, maleic anhydride or their esters, and will have a tensile modulus up to about 50,000 psi determined according to ASTM D638. Suitable higher alpha-olefins include C₃ to C₈ alpha-olefins such as, for example, propylene, butene-1, hexene-1 and styrene. Alternatively, copolymers having structures comprising such units may also be obtained by hydrogenation of suitable homopolymers and copolymers of polymerized 1-3 diene monomers. For example, polybutadienes having varying levels of pendant vinyl units are readily obtained, and these may be hydrogenated to provide ethylene-butene copolymer structures. Similarly, hydrogenation of polyisoprenes may be employed to provide equivalent ethylene-isobutylene copolymers. The functionalized polyolefins that may be used in the present invention include those having a melt index in the range of about 0.5 to about 200 g/10 min.

Suitable dienes for use in the preparation of ethylene-alpha-olefin-diene terpolymers are non-conjugated dienes having 4 to about 24 carbon atoms, examples of which include 1,4-hexadiene, dicyclopentadiene and alkylidene norbornenes such as 5-ethylidene-2-norbornene. Mole fractions of ethylene units and higher alpha-olefin units in the ethylene-higher alpha-olefin copolymer rubbers generally range from about 40:60 to about 95:5. Ethylene-propylene copolymers having about 50 to about 95 mol % ethylene units and about 5 to about 50 mol % propylene units are included among these. In terpolymers comprising polymerized diene monomer, the diene unit content can range up to about 10 mol %, and about 1 to about 5 mol % in certain embodiments. Also suitable are the corresponding block copolymers comprising two or more polymeric blocks, each formed of one or more monomers selected from ethylene and the higher alpha-olefin. The functionalized polyolefins will generally further comprise about 0.1 to about 10 wt % functional groups.

Other impact modifiers useful herein include those described in U.S. Pat. No. 6,765,062 (Ciba Specialty Chemicals Corporation) and EP 901 507 B1 (DuPont).

Still other impact modifiers useful herein include acrylic impact modifiers commercialized as Paraloid® impact modifiers by Rohm & Haas.

The impact modifier, if present in the composition (C), is generally present in an amount of at least 0.1 wt %, preferably of at least 0.5 wt %, more preferably of at least 2 wt %, still more preferably of at least 4 wt % and most preferably of at least 5 wt %, based on the total weight of the composition (C). Besides, the impact modifier is generally present in the composition (C) in an amount of at most 40 wt %, based on the total weight of the composition (C). Preferably, the impact modifier is generally present in the composition (C) in an amount of at most 35 wt %, more preferably of at most 30 wt %, still more preferably of at most 25 wt %, even more preferably of at most 20 wt %, yet more preferably of at most 18 wt % and most preferably of at most 15 wt %, based on the total weight of the composition (C).

The impact modifier and aromatic polyamide can be mixed together in any manner, and mixing can occur before, e.g., extrusion, or the materials may be mixed in the extruder.

More than one impact modifier may be used in composition (C).

### Other Optional Ingredients of the High Heat Resistant Polyamide Composition (C)

The composition (C) can optionally comprise additional additives/components such as other polymers, fillers, pigments, dyes, lubricants, thermal stabilizers, light stabilizers, flame retardants and antioxidants, etc.

The composition (C) may further comprise other polymers than the above described polyamide. In particular, it may, for example, comprise at least one additional polymer selected from the group consisting of polyphenylsulfide, poly(ether ether ketone), etc.

A large selection of reinforcing fillers may be added to the composition (C). They are preferably selected from fibrous and particulate fillers. A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5. Preferably, the aspect ratio of the reinforcing fibers is at least 10, more preferably at least 20, still more preferably at least 50.

Preferably, the reinforcing filler is selected from mineral fillers (such as talc, mica, kaolin, calcium carbonate, calcium silicate, magnesium carbonate), glass fiber, carbon fibers, synthetic polymeric fiber, aramid fiber, aluminum fiber, titanium fiber, magnesium fiber, boron carbide fibers, rock wool fiber, steel fiber, wollastonite, etc. Still more preferably, it is selected from mica, kaolin, calcium silicate, magnesium carbonate and glass fiber, etc.

Among fibrous fillers, glass fibers are preferred; they include chopped strand A-, E-, C-, D-, S- and R-glass fibers, as described in chapter 5.2.3, pages 43-48 of Additives for Plastics Handbook, 2nd ed, John Murphy. Preferably, the filler is chosen from fibrous fillers. It is more preferably a reinforcing fiber that is able to withstand the high temperature applications.

In a preferred embodiment of the present invention the reinforcing filler is chosen from wollastonite and glass fiber. Excellent results were obtained when glass fibers were used. Glass fibers may have a round cross-section or a non-circular cross-section.

Excellent results were obtained when the reinforcing filler was used in an amount of 20-60 wt %, preferably of 30-50 wt %, based on the total weight of the composition (C).

The fillers are contained in the composition (C) in a total amount of advantageously more than 15% by weight, preferably more than 20% by weight, still more preferably more than 25% by weight, and most preferably more than 30% by weight, based on the total weight of the composition (C). On the other hand, reinforcing fibers are contained in the composition (C) in a total amount of advantageously less than 65% by weight, preferably less than 60% by weight, still more preferably less than 55% by weight, and most preferably less than 50% by weight, based on the total weight of the composition (C).

The composition (C) may further comprise pigments and dyes. It may notably comprise black pigments such as carbon black and nigrosine.

The composition (C) may further comprise lubricants such as linear low density polyethylene, calcium or magnesium stearate, sodium montanate, etc.

The composition (C) further comprises in another preferred embodiment, in addition to the elemental iron or the polyhydric alcohol thermal stabilizers, at least a well known thermal stabilizer different from the elemental iron or the polyhydric alcohol that further promote the heat aging properties. They can typically be one or more selected from phenolic thermal stabilizers (such as Irganox® 1098 or Irganox® 1010, available from Ciba Specialty Chemicals); organic phosphites (such as Irgafos® 168, available from Ciba Specialty Chemicals); aromatic amines; metals salts of elements from group IB, IIB, III and IV of the periodic Table; and metal halides of alkaline and alkaline earth metals.

Preferably, the composition (C) further comprises a combination of a copper salt and an alkaline metal halide. More preferably, it comprises a copper halide and an alkaline metal halide, such as CuI and KI. Most preferably, CuI and KI are used in a ratio varying from 1/6 to 1/10, preferably 1/7 to 1/9.

This further thermal stabilizer may be present in an amount of from 0.1 to 5 wt %, preferably of from 0.2 to 2.5 wt %.

Light stabilizers such as hindered amine light stabilizers (HALS) may also be present in the composition (C).

The composition (C) may further comprise flame retardants such as halogen and halogen free flame retardants.

The preparation of the composition (C) can be carried out by any known melt-mixing process that is suitable for preparing thermoplastic molding compositions. Such a process is typically carried out by heating the thermoplastic polymer above the melting temperature of the thermoplastic polymer thereby forming a melt of the thermoplastic polymer. The process for the preparation of the composition (C) can be carried out in a melt-mixing apparatus, for which any melt-mixing apparatus known to the one skilled in the art of preparing polymer compositions by melt mixing can be used. Suitable melt-mixing apparatus are, for example, kneaders, Banbury mixers, single-screw extruders, and twin-screw extruders. Preferably, use is made of an extruder fitted with means for dosing all the desired components to the extruder, either to the extruder's throat or to the melt. In the process for the preparation of the composition (C) the constituting components for forming the composition are fed to the melt-mixing apparatus and melt-mixed in that apparatus. The constituting components may be fed simultaneously as a powder mixture or granule mixer, also known as dry-blend, or may be fed separately. The process for the preparation of the composition (C) is not limited in the way the additives are added. In particular, the elemental iron may be added, for example, as a powder, a dry-blend or premix comprising the thermoplastic polymer in granulate form and the elemental iron in powder form, or as a masterbatch of finely dispersed elemental iron in a carrier polymer.

A further object of the present invention relates to a method for the extraction of oil/gas from underground reservoirs using the above-mentioned rod guide.

Another object of the present invention relates to an oil/gas extraction device comprising the above described rod guide.

Still another object of the present invention relates to a method for the protection of a sucker rod for the extraction of oil/gas from underground reservoirs using the above described rod guide. Accordingly, a further object of the invention pertains to a sucker rod or a sucker rod module comprising at least one rod guide according to the present invention.

The invention is further illustrated with the following examples and comparative examples whose purpose is merely illustrative and not intended to limit the scope thereof.

### EXAMPLES

Rod guides may be manufactured from various resins. The most common ones are based on PPA, Nylon 6,6 and PPS which generally give good cost vs. performance ratios. Table 1 below reports comparative performances of various rod guides differing from the base polymer from which they were manufactured.

TABLE 1
Comparative performances of rod guides

| Maximum | | | | | |
|---|---|---|---|---|---|
| working | RATING (1 = Excellent; 2 = Good; 3 = Average; 4 = Poor) | | | | |
| temperature | Resistance to | Resistance to | Resistance to | Corrosion | Chemical |
| (° C.) | hot oil | brine | sour crude | resistance | resistance |

Comparative rod guides:

| | | | | | | |
|---|---|---|---|---|---|---|
| based on | 200 | 1 | 2 | 2 | 2 | 2 |
| PPA | | | | | | |
| based on | 135 | 3 | 4 | 4 | 3 | 3 |
| Nylon 6,6 | | | | | | |
| based on | 200 | 1 | 1 | 1 | 1 | 1 |
| PPS | | | | | | |

Rod guide according to the invention:

| | | | | | | |
|---|---|---|---|---|---|---|
| based on | 250 | 1 | 2 | 2 | 2 | 2 |
| high heat | | | | | | |
| resistant | | | | | | |
| PPA | | | | | | |

The rod guides, according to the present invention, can sustain working temperatures as high as 230-250° C., while the prior art rod-guides only allows working temperatures of maximum 200° C.

Rod guides according to the present invention may for example be manufactured from three compositions (E1, E2, and E3) which were prepared as follows:

### Components and Ingredients Used:

(1) PA 1: Vicnyl 600, PA10,T/10,6 (92/8) available from Kingfa;
(2) PA 2: PA 6 Ultramid® 8202 HS from BASF;
(3) PA 3: Amodel® A-4002, PA 6,T/6,6 (65/35) available from Solvay Specialty Polymers USA, LLC;
(3) Stabilizer: mixture of copper iodide and potassium iodide in a 1/9 ratio with a stearate binder;
(4) Compatibilizer: Fusabond® MB226 from Dupont™ (anhydride modified LLDPE);
(5) Elemental iron masterbatch: SHELFPLUS™ O₂ 2400 from ALBIS Plastic

Corporation, masterbatch containing 20 wt % of elemental iron particles in polyethylene having a D99 particle size of 63 μm;
(6) Fiberglass: HP3540 chopped strand 10 micron diameter commercialized by PPG Industries.

### Preparation of the Polymer Compositions

Examples E1, E2, and E3 were prepared by melt blending the ingredients listed in Table 2 in a 26 mm twin screw extruder (ZSK 26 by Coperion) operating at about 290° C. barrel setting using a screw speed of about 200 rpm, a throughput of 13.6 kg/hour and a melt temperature of about 310-325° C. The fiberglass 1 or 2 were added to the melt through a screw side feeder. Ingredient quantities shown in Table 2 are given in weight % on the basis of the total weight of the polymer composition.

The compounded mixture was extruded in the form of strands cooled in a water bath, chopped into granules and placed into sealed aluminum lined bags in order to prevent moisture pickup. The cooling and cutting conditions were adjusted to ensure that the materials were kept below 0.15 wt % of moisture level.

TABLE 2
Nature and quantities in wt % of the ingredients of the prepared
compositions

| | E1 | E2 | E3 |
|---|---|---|---|
| PA1 | 52.54 | | |
| PA2 | 5 | 5 | 10 |
| PA 3 | | 52.54 | 47.54 |
| Stabilizer | 0.81 | 0.81 | 0.81 |
| Compatibilizer | 1.65 | 1.65 | 1.65 |
| Elemental iron masterbatch | 5 | 5 | 5 |
| Fiberglass | 35 | 35 | 35 |

### Initial Properties of the Polymer Compositions

Initial mechanical tensile properties, i.e. stress at break (tensile strength) and strain at break (elongation at break), were measured according to ISO 527-2/1A and are reported in Tables 3 and 4 at aging time of 0 hour. Measurements were made on injection molded ISO tensile bars. Mold temperature for the test specimen ranged from 115-120° C. and melt temperature ranged from 315-330° C.

The thickness of the test bars was 4 mm and their width was of 10 mm. According to ISO 527-2/1A, the tensile strength and elongation were determined at a testing speed of 5 mm/min.

### Thermal Oxidation Aging

The test bars were heat aged in a re-circulating air oven (Blue M) at a temperature set at 230° C., according to the procedure detailed in ISO 2578. At various heat aging times, the test bars were removed from the oven, allowed to cool down to room temperature and sealed into aluminum-lined bags until ready for testing. The tensile mechanical properties were then measured according to ISO 527 as described above. All values reported in Tables 3 and 4 are average values obtained from 5 specimens.

TABLE 3
Tensile strength results in MPa

| Heat aging time in hours | E1 | E2 | E3 |
|---|---|---|---|
| 0 | 183.28 | 192 | 193 |
| 48 | 156.02 | 148 | 156 |
| 96 | 144.04 | 131 | 145 |
| 500 | 168.76 | 136 | 140 |
| 1000 | 167.69 | 138 | 146 |
| 2000 | 180.3 | 146 | 158 |
| 3000 | 185.75 | 152 | 172 |
| 4000 | 186.82 | 169 | 180 |
| 5000 | — | 158 | 175 |

TABLE 4
Tensile elongation results in %

| Heat aging time in hours | E1 | E2 | E3 |
|---|---|---|---|
| 0 | 2.57 | 1.91 | 1.97 |
| 48 | 1.6 | 1.28 | 1.35 |
| 96 | 1.43 | 1.11 | 1.23 |
| 500 | 1.81 | 1.15 | 1.18 |
| 1000 | 1.84 | 1.15 | 1.24 |
| 2000 | 2.03 | 1.26 | 1.4 |
| 3000 | 2.17 | 1.33 | 1.57 |
| 4000 | 2.2 | 1.5 | 1.66 |
| 5000 | — | 1.43 | 1.67 |

The polymer composition (C) having the excellent retention of tensile strength and/or elongation at break, tested after heat aging, is an ideal candidate for the manufacture of rod guides according to the present invention having an extended lifetime or can be used at high continuous use temperature.

1. A rod guide comprising at least one part comprising a high heat resistant polyamide composition (C) comprising:
at least one polyamide; and
at least one heat stabilizing additive selected from elemental iron and polyhydric alcohols.

2. A rod guide according to claim 1 wherein the high heat resistant polyamide composition (C) further comprises an impact modifier.

3. A rod guide according to claim 2, wherein the impact modifier is a functionalized polyolefin impact modifier.

4. A rod guide according to claim 2, wherein the impact modifier is present in said high heat resistant polyamide composition (C) in an amount of at least 2 wt % and of at most 40 wt %, based on the total weight of the composition (C).

5. A rod guide according to claim 1, wherein the high heat resistant polyamide composition (C) comprises a reinforcing filler.

6. A rod guide according to claim 1, wherein the at least one polyamide is selected from the group consisting of semi-aromatic polyamides and aliphatic polyamides.

7. A rod guide according to claim 6, wherein the semi-aromatic polyamide is a polyphthalamide.

8. A rod guide according to claim 7, wherein the polyphthalamide is selected from the group consisting of PA6T, PA9T, PA10T, PA11T, PA12T, PA6T/6I, PA6T/6I/10T/10I, PA6T/10T/6,10/10,10, PA6T/11 and PA10T/11.

9. A rod guide according to claim 1, wherein the heat stabilizing additive comprises elemental iron.

10. A rod guide according to claim 9, wherein the elemental iron is present in the composition (C) in an amount of at least 0.1 wt % and of at most 10 wt %, based on the total weight of the composition (C).

11. A rod guide according to claim 1, wherein the heat stabilizing additive comprises a polyhydric alcohol.

12. A rod guide according to claim 11, wherein the polyhydric alcohol is present in an amount of at least 0.1 wt % and of at most 10 wt %, based on the total weight of the composition (C).

13. A rod guide according to claim 11, wherein the polyhydric alcohol comprises dipentaerythritol.

14. A method for the protection of a sucker rod for the extraction of oil/gas from underground reservoirs using the rod guide according to claim 1.

15. An oil/gas extraction device comprising the rod guide according to claim 1.

16. A rod guide according to claim 5, wherein the reinforcing filler is a fibrous reinforcing filler.

17. A rod guide, comprising at least one part comprising a high heat resistant polyamide composition (C) comprising:
at least one polyphthalamide selected from the group consisting of PA6T, PA9T, PA10T, PA11T, PA12T, PA6T/6I, PA6T/6I/10T/10I, PA6T/10T/6,10/10,10, PA6T/11 and PA10T/11,
from 30 wt % to 60 wt % chopped glass fiber reinforcing filler, and
from 0.1 wt % to 10 wt % elemental iron particles,
each based on the total weight of the composition (C).
